(19) United States
(12) Patent Application Publication
(10) Pub. No.: US 2002/0028419 A1
(43) Pub. Date: Mar. 7, 2002

(54) Dental hand tool for interproximal dental restorations

(76) Inventor: Charles E. Slone, San Juan Capistrano, CA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/927,168

(22) Filed: Aug. 9, 2001

Related U.S. Application Data
(63) Continuation-in-part of application No. 09/502,432, filed on Feb. 11, 2000, now Pat. No. 6,229,275.

(51) Int. Cl. A61C 3/00

(52) U.S. Cl. 433/29; 433/164

(57) ABSTRACT

A light concentrating dental tool apparatus has an elongate handle defining a longitudinal axis and a light transmissive utility element at one or both ends of the handle. The utility element providing an outwardly facing, light receiving, top surface, and a downwardly converging cone-shaped body terminating with an integral workpiece adapted for moving a dental matrix band. A light disbursing surface directs light outwardly for curing a dental resin. The light disbursing surface provides a downwardly directed flat portion used for leverage against the dental preparation, and a downwardly curved portion in mutually opposing juxtaposition, for pressing against the matrix band. The flat and the curved portions define a common axis of symmetry forming an angle with said longitudinal axis so as to allow the tool to be used to provide improved visibility by the practitioner. A tapered mounting structure enables the utility element to be removed and reset within the handle at a selected angle.

This application is a Continuation-In-Part of Ser. No. 09/502,432 filed Feb. 11, 2000.

### BACKGROUND OF THE INVENTION

1. Field of the Invention

This invention relates generally to dental tools for tooth restoration; and, more particularly, to a dental tool for achieving optimum interproximal dental restorations.

2. Description of Related Art

The following art defines the present state of this field:

Cartwright et. al. U.S. Pat. No. 2,138,726 describes a girdling tool having two handles, each handle terminating at one end with a jaw, said handles being pivotally connected, adapting the jaws to be opened and closed, cutting blades convex in shape, each blade terminating at an approximate point, said blades being arranged on the jaws in pairs, the blades forming each pair being positioned on diverging planes, the greatest divergence between the blades of each pair being at the points of the blades, two pairs of blades being attached to one jaw, the two pairs of blades thereon being arranged so that the sharpened edges of one pair diverge from the sharpened edges of the other pair, the cooperating jaw having one pair of blades thereon, the one pair of blades on said cooperating jaw being positioned so that the sharpened edges thereof are on the same approximate plane as the cooperating blades on the jaw having two pairs of blades thereon.

Rabl et. al. U.S. Pat. No. 4,130,107, describes a device provided for the collection and concentration of radiant energy and including at least one reflective side wall. The wall directs incident radiant energy to the exit aperture thereof or onto the surface of an energy absorber positioned at the exit aperture so that the angle of incidence of radiant energy at the exit aperture or on the surface of the energy absorber is restricted to desired values.

Winston et. al. U.S. Pat No. 4,240,692 describes a radiant energy transmitting devices operative selectively in concentrative and emissive modes, having transmitting elements including radiant energy transmitting and guiding surfaces at the interface of media of differing indices of refraction for radiant energy. Surfaces generally are of a concavely sloping configuration consistent with reflecting, for example, extremal energy rays entering the element from within a defined field of acceptance at an energy inlet onto an energy trap or, in the alternative, extremal rays from an energy source through an energy outlet within a defined field of emission. The energy source or trap is preferably an energy transducer such as a photoelectric device.

Das, et. al. U.S. 4,365,957, describes a periodontal surgical instrument which includes a handle, shank and a cutting head. The cutting head possesses two interior surgical blades each possessing terminus points having their confluence at a substantial V-shape to form an apex. At least one exterior surgical blade is positioned on the cutting head with its beginning at a first point substantially equal to the terminus of one of the adjacent blades. A method of use is also described for this periodontal surgical instrument for Gingivectomy and Gingivoplasty operations.

Barrett et. al. U.S. Pat. No. 4,608,021 describes a method and apparatus for restoration of teeth using light curable restoratives while assuring interproximal contact between the restored tooth and an adjacent tooth. The apparatus is in the form of a triangle-like block defining two arms converging at a common point and which are of a different length. The longer of the two arms is provided with a canning surface on the end thereof opposite from the common pointed edge whereas the shorter of the two arms is provided with an abutment surface on the end thereof opposite from the common pointed edge. A tooth cavitation opening through a vertical tooth surface about which a matrix band has been tightened is filled by alternate deposition and curing of successive layers of the light curable restorative to a level at or below the plane of the maximum circumference of the tooth. The block is placed with the shorter arm against the top of the previously cured filling with the abutment surface against the matrix band so that a ledge of cured restorative may be built about the pointed end of the block. Thereafter, the block is removed and reinserted with the longer leg down and operable as a camming strut pivotable about the previously formed step or ledge against the matrix band to deform it outwardly for subsequent filling and curing of the restorative.

Ericson, et. al. U.S. Pat. No. 4,666,405, describes a method of preparing a class II dental filling of a light-hardening filling material in a drilled-out tooth surrounded by a matrix band, the drilled-out tooth is filled with a light-hardening filling material in which the lower part of a light-transmitting adapter having a recess and attached to a light conductor, is pushed down into a filling material so that light is spread in the deeper parts of the filling, while at the same time the lower part of the adapter is pressed against the point of contact of the adjacent tooth while the filling is hardened so that satisfactory proximal contact is obtained. A light-transmitting adapter comprises an upper part having a recess for receiving a light conductor and a conical lower part adapted to conduct light-hardening filling material down into a drilled-out tooth. The lower part of the adapter is pressed against a matrix band surrounding the tooth so that satisfactory proximal contact with the adjacent tooth is obtained, while at the same time the deeper parts of the filling are made accessible to light from the light conductor.

Maitland et. al. U.S. Pat. No. 4,696,646 describes a device for use in composite resin dental restoration and a method for overcoming the difficulty of establishing sufficient separation to provide firm and properly located interproximal contact. This invention creates an easy, predictable method for establishing proper interproximal contact pressure and anatomical form. The wedge is used in a method which establishes predictable interproximal static contour relationships with matrix systems, providing the necessary additional interproximal separation and reducing the thickness of the composite resin to be cured by light catalysis to insure more complete curing in the deeper recesses in the cavity preparation.

Bowen et. al. U.S. Pat No. 4,744,759 describes a means to decrease the effects of polymerization shrinkage, increase stiffness, decrease the coefficient of thermal expansion and improve the durability of composite restorations by use of inserts are disclosed. Pieces of an aluminoborosilicate glass are phase-separated by heating to 870. degree. C. for 2 hours producing opaque inserts with silica-rich surfaces. Boiling for 1 hour in aqueous 0.5 N NaOH solution removes the surface layer, and produces a rough-textured surface with increased area. The surface texture plus treatment with an organofunctional silane provides for both micromechanical and chemical bonding with composite resins. Cavities in teeth are partially filled with unhardened composite material, and inserts of appropriate size and shape are pressed into the cavity so that the insert constitutes as much as possible of the finished restoration and its surface. The excess extruded composite material is removed with a hand instrument, and the composite containing the insert is light cured. The glass insert, together with the surrounding hardened composite, is contoured with high-speed rotary diamond instruments. Alternative types of inserts are also described.

Meinershagen et. al. U.S. Pat. No. 4,836,781 describes a dental tool for assisting in cavity repair in two adjacent teeth by facilitating removal of matrix bands therefrom after installation of filler restoration material. The tool includes a shank terminating in a bifurcated end portion, each branch of the bifurcated end portion terminating in a working surface having an inner edge. The inner edges of the working surfaces are separated by a gap having a width sufficiently large to accommodate a dental matrix band and sufficiently narrow to enable the working surfaces to maintain tight common interproximal contact with the filler restoration material in adjacent teeth.

Mitnick et. al. U.S. Pat. No. 5,030,093, describes a method and apparatus for placing, compacting and shaping a light-activated dental restorative material in a cavity preparation or between adjacent teeth and for polymerizing said restorative material in said cavity preparation or between said teeth to produce a restorative. A mirror/oral illuminator and a combination mirror and fiber optic probe are also disclosed.

Lazarof et. al. U.S. Pat. No. 5,098,292 describes a dental instrument for use in filling cavities in teeth with a light-activated filling compound which includes a condensing tip constructed from a plastic or glass fiber optic material. A source of light, either external to the instrument, or contained therewithin, can be selectively energized to enable controlled activation of the activator in the filling compound as the compound is being packed and shaped within the cavity by the condenser tip of the instrument. The dental instrument includes a suction cup removably connected to the tip for releasably gripping a dental overlay.

Slone et. al. U.S. Pat. No. 5,318,446, describes an apparatus and method for preparing a tight proximal contact between a tooth to be filled and an adjacent tooth. A tool head provides a first convex surface extending downwardly to a linear ridge. The head is divided into a pair of side-by-side fingers separated by a channel. The linear ridge defines the tip of each finger. The head is of a size to fit into a prepared cavity in a tooth. The head further provides a stepped surface, in opposition to the first convex surface, that extends downwardly to the linear ridge. Alternately, the head provides a second convex surface, in opposition to the first convex surface, that extends downwardly to the linear ridge. An elongated tool handle has a first and a second opposing bent ends. The first bent end is at 90 degrees, while the second end is at 45 degrees, such that the single tool may enable the formation of both distal and mesial contacts.

Schumacher et. al. U.S. Pat No. 5,358,404, describes an apparatus for compressing and adapting filling material introduced into a dental cavity with an elastic punch which is fixed in or on a holder.

Maissami et. al. U.S. Pat. No. 5,791,898 describes an improved light-transmitting apparatus and methods for polymerizing light-hardening dental fillings of Class II resins. In the improved apparatus and methods, a magnified prism is constructed in the middle of a light-transmitting apparatus that transforms broad light from a light transmitting source to a concentrated light to the center of the focal point of the tip of the apparatus. The improved apparatus and methods permit the optional connection of the light-transmitting apparatus to a light source.

The prior art describes various mechanisms, relating to dental tools for filling cavities and the efficient collection of light for curing filling materials. Both Winston et. al. U.S. Pat. No. 4,240,692 and Rabl et. al. U.S. Pat. No. 4,130,107, describe devices for the collection and concentration or transmission of radiant energy using reflective side walls. However, the prior art does not teach a dental tool apparatus with enhanced light-concentrating means and a means for reducing the effect of cured composite shrinkage during tooth restoration which also is enabled to ensure the ideal contact between the restored tooth and an adjacent distal or mesial tooth after restoration. The prior art also does not teach the placement of a preferred angle of the tool's workpiece with the axis of the tool such that the handle may be positioned to one side of the mouth for improved visibility; and also does not teach the use of tapered surface mounting of the workpiece within the handle which enables selection of any preferred work angle. The present invention fulfills these needs and provides further related advantages as described in the following summary.

### SUMMARY OF THE INVENTION

The present invention teaches certain benefits in construction and use, which give rise to the objectives described below.

A light concentrating dental tool apparatus has an elongate handle defining a longitudinal axis and a light transmissive utility element at one or both ends of the handle. The utility element provides an upwardly facing, light receiving, top surface, and a downwardly converging cone-shaped body terminating with an integral workpiece adapted for moving a dental matrix band. A light disbursing surface directs light outwardly for curing a dental resin. The light disbursing surface provides a downwardly directed flat portion used for leverage against the dental preparation, and a downwardly directed curved portion in mutually opposing juxtaposition, for pressing against the matrix band. The flat and the curved portions define a common horizontal axis of symmetry forming an angle with said longitudinal axis so as to allow the tool to be positioned to provide improved visibility to the technician. A tapered mounting structure enables the utility element to be removably mounted within the handle at a selected angle.

A primary objective of the present invention is to provide a dental apparatus having advantages not taught by the prior art.

Another objective is to allow a dentist to obtain tight proximal contacts easily and quickly.

A further objective is to increase the life of the instrument by coating it with a hard layer.

A further objective is to provide for a proper anatomically shaped restoration with convex surfaces ideally positioned.

A further objective is to provide maximum light throughput to the tip of the instrument.

A further objective is to enable pressure to be applied at either the distal or mesial end of the instrument through a simple manual push or pull movement.

A further objective is to minimize the effect of shrinkage of the curable composite resin in a proximal box.

A further objective is to allow ideal positioning of the apparatus relative to the occlusal plane.

A further objective is to allow replacement of the utility elements of the tool when worn.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a side elevational view of an embodiment of the present invention;

FIG. 2 is a partial view of thereof showing proper finger positioning while using a distal tip of the invention and enabling a pushing motion;

FIG. 3 is similar to FIG. 2 but showing proper finger positioning while using a mesial tip of the invention for pulling motion;

FIG. 4 is an elevational view thereof as applied with a curing lamp and the end of the tool shown in section;

FIG. 5 is a top plan view thereof;

FIGS. 6 and 7 are enlarged views of the distal and mesial tips thereof showing a penetration depth guide;

FIG. 8 is a schematic diagram of the invention in elevation, showing typical light rays transmitted within and into a composite resin adjacent thereto;

FIG. 9 is a perspective view showing placement of a matrix band on a tooth and placement of a curable composite resin and the invention therein;

FIG. 10 is an elevational view thereof showing a composite resin post cure;

FIG. 11 is a top plan view thereof showing the manner of placement of a matrix band, curable composite resin and placement of the invention therein;

FIGS. 12 and 13 are elevational schematic views thereof showing proper placement of the distal and mesial tips respectively;

FIG. 14 is a perspective view showing proper alignment of a light source with the mesial tip;

FIGS. 15 and 16 are partial plan views of a further preferred embodiment of the invention, showing my new and improved apparatus with preferred angular positions of the workpiece of the invention;

FIG. 17 is a partial plan view thereof showing offset positions of the invention during use;

FIG. 18 is a partial plan view thereof showing non-offset positions of the tool during use; and

FIG. 19 is a partial exploded sectional side view of the handle and side view of the utility element of the invention illustrating the method of mounting the utility element within the handle.

### DETAILED DESCRIPTION OF THE INVENTION

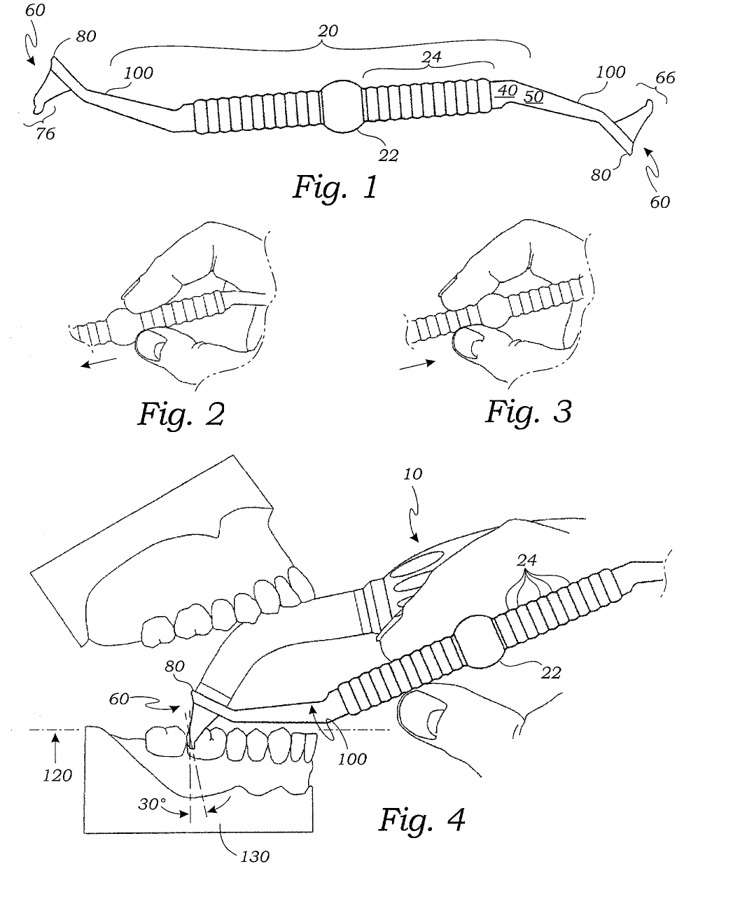

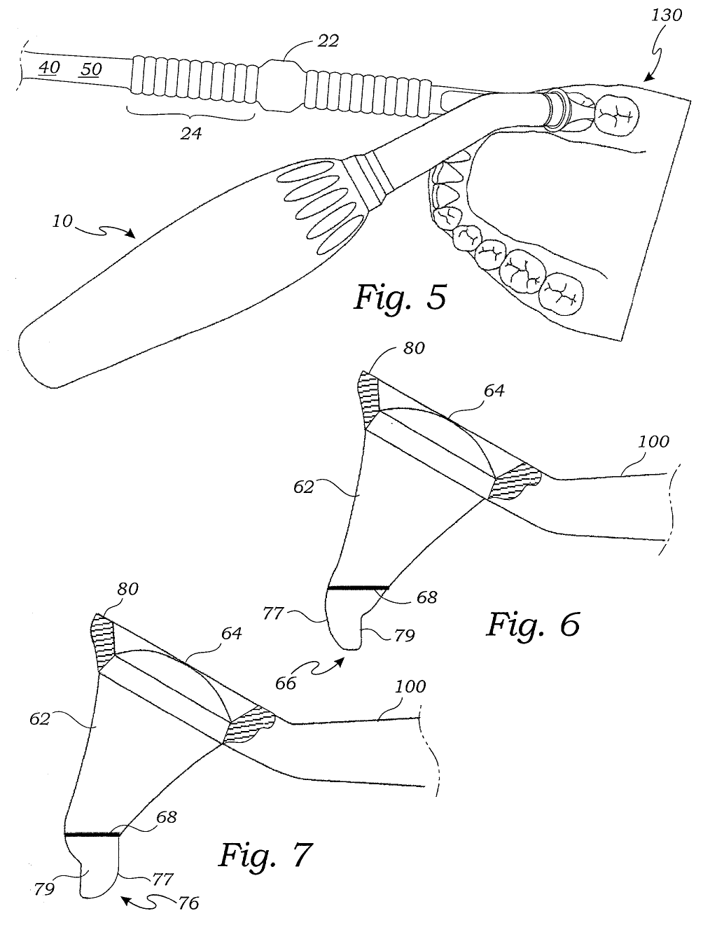

FIG. 1 illustrates the invention, an apparatus tool for preparing a tight proximal contact between a tooth to be filled 5 and an adjacent tooth 6 (FIG. 11) where the filling requires reconstruction of the contact wall of the tooth to be filled 5. This description of the apparatus incorporates, by reference, a prior patent by the present applicant, Slone et. al U.S. Pat. No. 5,318,446, which is attached hereto. The present apparatus distinguishes over the prior patent in several ways as will be clearly shown. The invention apparatus is a light-concentrating dental hand tool for use with a light curing lamp 10, preferably using visible light. The apparatus comprises an elongate handle 20, approximately four to six inches in length and weighing no more than about two ounces, and it provides an ergonomic design allowing both distal and mesial contacts to be made with equal ease. The handle 20 is manufactured from a light-transparent and light-transmissive material comprised of a steam autoclaveable, optically transparent engineering polymer such as polycarbonate. Inventively, the apparatus' entire outer surface 50 is coated with a proprietary hard amorphous layer 40. This proprietary hard layer 40 preferably has diamond-like properties, including high hardness, optical transparency, high electrical resistance, chemical resistance, elasticity, and a very low coefficient of friction, which increases wear resistance of the apparatus.

The handle 20 includes a medially positioned enlarged portion 22, preferably spherical, as shown in FIGS. 1-4, which helps in positioning the handle 20. The medially positioned enlarged portion 22 provides an enhanced gripping surface and a series of concentric annular grooves 24 provide a firm and improved grip, thereby improving leverage.

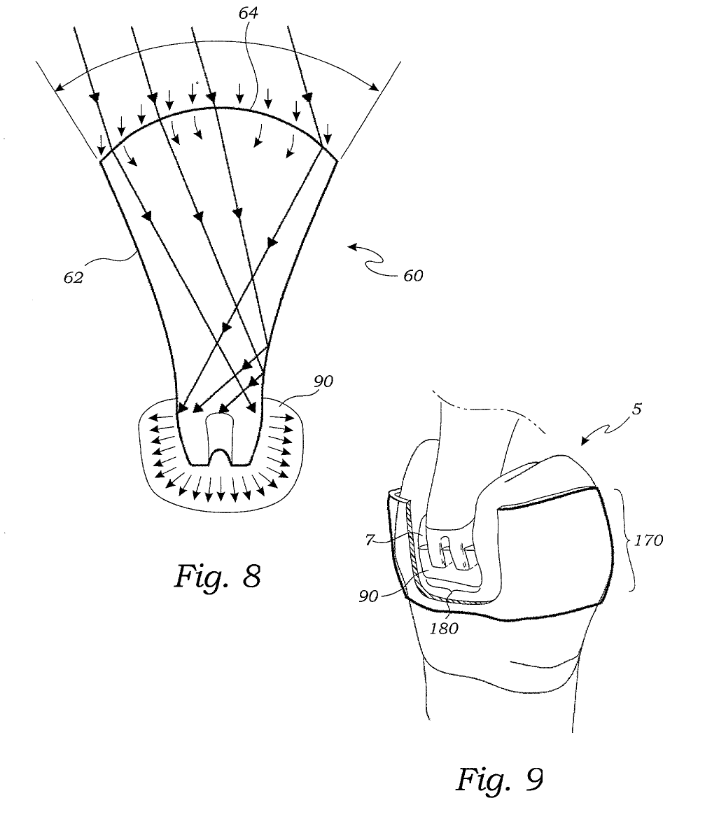

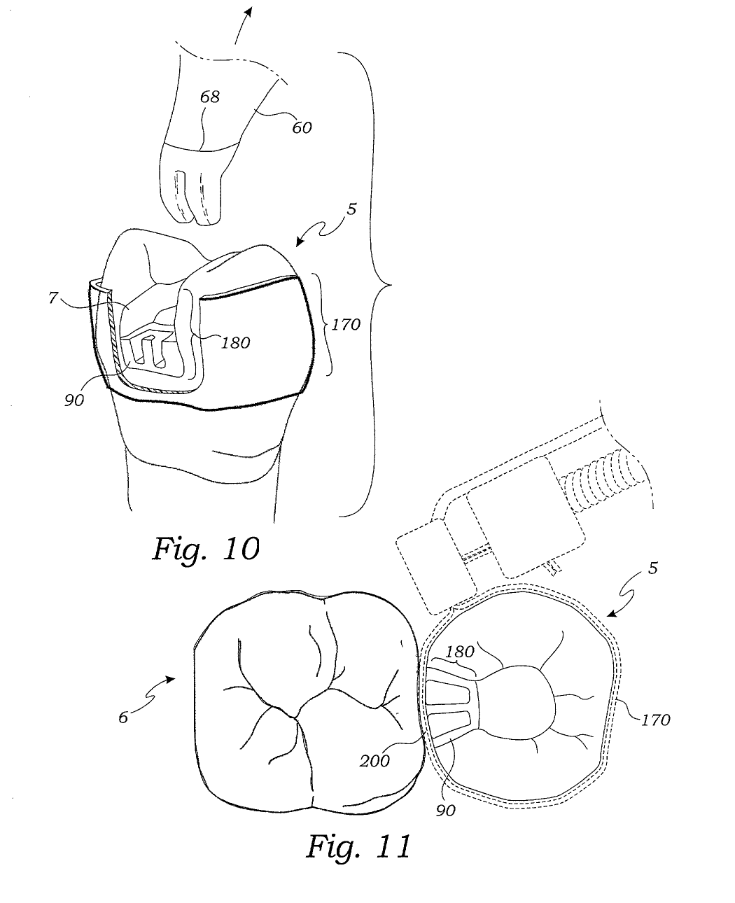

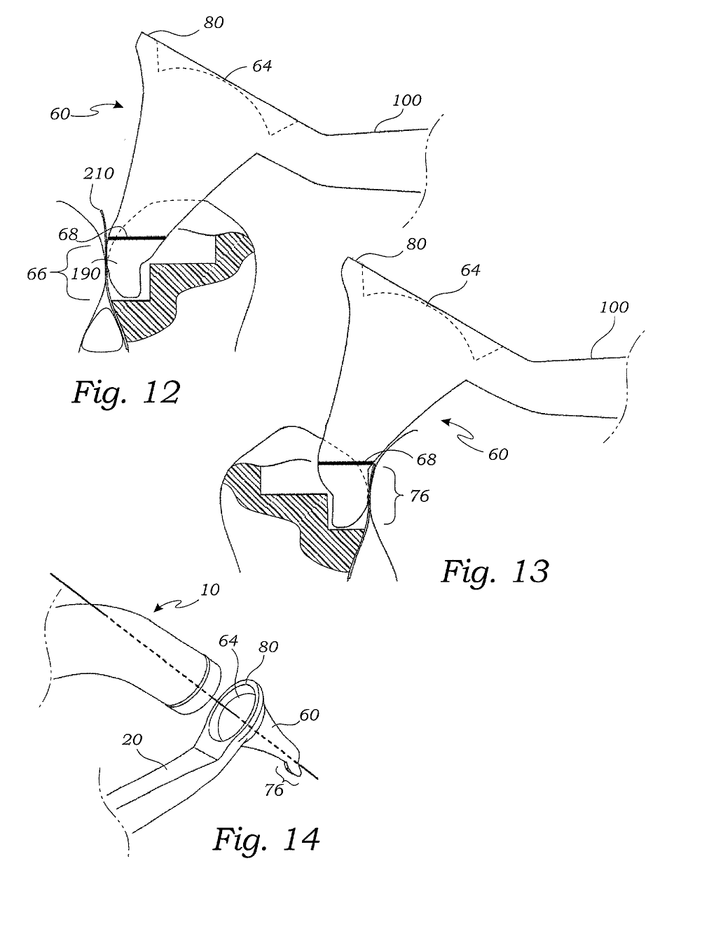

The handle 20 provides, at each of its opposing ends, a utility element 60, as shown in FIG. 1. The utility elements 60 include a modified and truncated cone shaped body 62 with a hyperbolic outer surface which minimizes losses as light passes through the body 62 as shown diagrammatically in FIG. 8. The utility element 60 has a convex, preferably spherical, outwardly facing surface 64 with an acceptance angle of at least 55 degrees, through which light is directed downwardly toward the lower portion of the utility element 60. This lower portion is referred to herein, generally, as the workpiece; a distal workpiece 66 adapted for pulling, shown in FIG. 6, and a mesial workpiece 76 adapted for pushing, and shown in FIG. 7. The handle 20 further provides, at each end, a resting surface 80 for placement of the visible light curing lamp 10, as best seen in FIG. 14. The resting surface 80 provides a flat annular lip surrounding the spherical surface 64 of the utility element 60.

As stated, the distal 66 and mesial 76 workpieces disburse light outwardly into a surrounding curable composite resin 90 as shown in FIG. 8, thereby enabling a light energy cure as is known in the art. The distal end workpiece 66 and the mesial end workpiece 76 are distinct from each other in shape as is clearly shown in FIGS. 6 and 7. Whereas both are rounded and convex on one side 77; the convex contour of the distal end workpiece 66 faces generally away from the technician, while the convex contour of mesial end workpiece 76 faces generally toward the technician. A pushing force is applied to the distal end workpiece 76, while a pulling force is applied to the mesial end workpiece 66 so as to move the tooth being repaired 5 during the curing step away from the adjacent tooth 6 so as to assure proper positioning of the contact wall surface.

The utility elements 60 provide marginal ridge guides 68 as shown in FIG. 6 and 7. These guides are circumferentially etched into the utility elements 60 to help the technician determine an ideal depth of insertion into the resin 90 of the workpiece 66 or 67.

The handle 20 provides flat surfaces 100 as shown in FIGS. 6 and 7 to help visually align the apparatus with the occlusal plane 120 (FIG. 4) of a mouth 130. The convex surface 64 is set at an angle of between 150 and 160 degrees with respect to the flat surface 100 of the tool at the respective ends. This angle allows the workpiece 60 to be positioned relative to the occlusal plane 120 at an ideal angle of 30 degrees off vertical as shown in FIG. 4.

After the curing of the resin 90, a hard bridging structure 200 remains between the tooth 5 and the adjacent tooth 6, as shown in FIG. 11. When the matrix band 170 is removed, the adjacent tooth 6 shifts back by approximately the width of the matrix band 170 so that contact between the tooth 5 and the adjacent tooth 6 is attained even after the matrix band 170 no longer separates the two teeth. The technician may now fill the remainder of the volume of the proximal box 180 with the resin 90, to complete the fill.

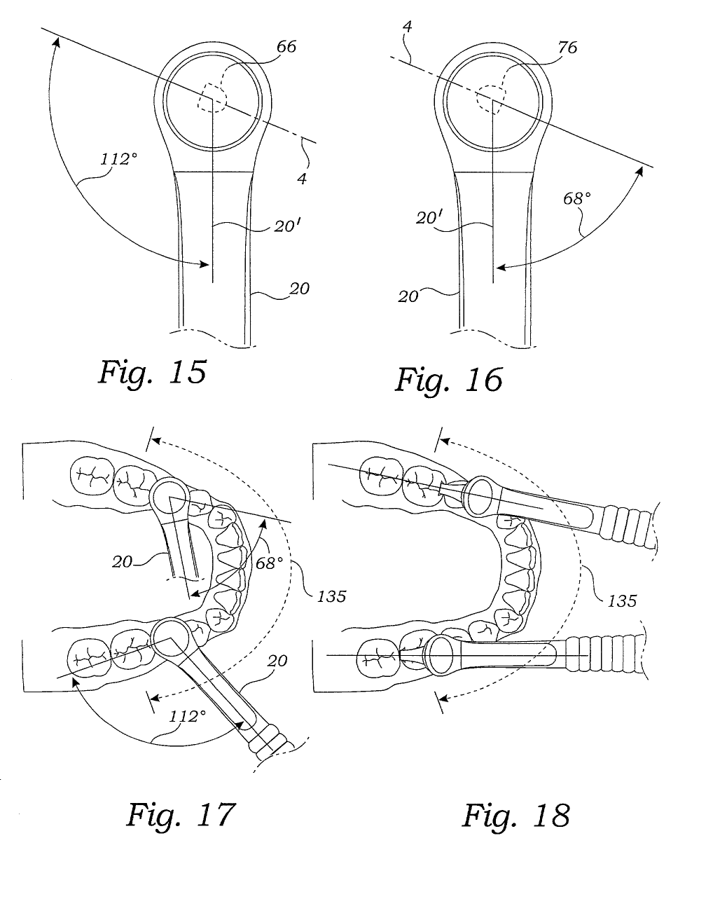

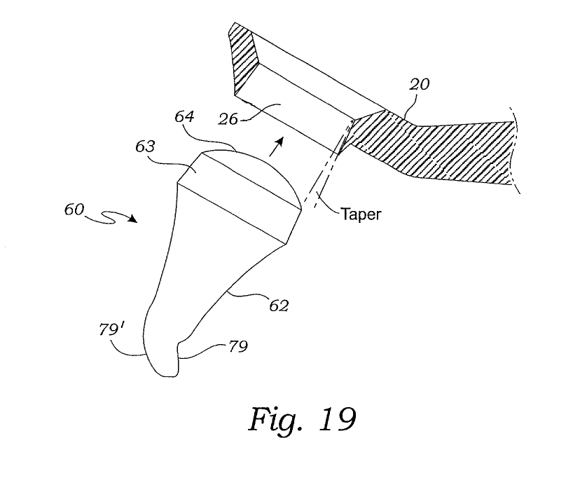

In a preferred embodiment of the present invention, the handle 20 defines a longitudinal axis 20′ thereof as shown in FIGS. 15 and 16. The light transmissive utility elements 60 are integral with the handle 20 at opposing ends as shown in FIG. 1. The workpieces provide, in use, a downwardly directed flat portion 79, and a downwardly curved portion 77 in mutually opposing juxtaposition as is clearly shown in FIG. 19. The flat 79 and the curved 77 portions define a common axis of symmetry 4, see FIGS. 15, 16. Depending on the mouth opening size and conformation of the patent, and whether adult or child, the angular range that is of particular use is as shown in FIG. 17 by numeral 135 and this dictates acceptable angles of the axis of symmetry 4, relative to the longitudinal axis of the tool 20′. FIG. 18 shows the invention where the common axis of symmetry 4 is aligned with the tool axis 20′. In preferred embodiments the mesial end of the apparatus provides an angle of between 59 and 77 degrees, and at the distal end of between 103 and 121 degrees, i.e., the angle between axis 4 and axis 20′. The preferred angles are 68 and 112 degrees respectively as these angles have been found in practice to provide the best visibility to the dental technician, without causing discomfort to the patient by applying aggressive pressure against one or the other of the side edges of the mouth. The comfort range for placement of dental tools within a typical patient's mouth has been found to be as is shown in FIG. 17 by numeral 135.

In a still further embodiment of the invention, the handle 20 provides a circular, inwardly facing tapered receiving surface 26 at each end thereof as shown in FIG. 19. The utility elements 60 provide a corresponding circular, outwardly facing tapered insertion surface, 63. The tapered surfaces 26 and 63 enable the utility elements 60 to be mounted within the handle 20 with the axis of symmetry 4 set at any chosen angle relative to said longitudinal axis 20′. The taper angle is preferably about 1.5 angular degrees which has been found to enable the utility elements to be held securely without further attachment means and to be readily removed as necessary. Other means for securing the utility element of the invention within the handle may be used to similar advantage.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A light concentrating dental tool apparatus for use with a curing lamp, the apparatus comprising: an elongate handle defining a longitudinal axis thereof; and a light transmissive utility element at one end of the handle, the utility element providing an outwardly facing, light receiving, top surface, and a downwardly converging coneshaped body, the body terminating with an integral workpiece adapted for moving a matrix band; the workpiece providing a light disbursing surface enabled for directing light outwardly therefrom for curing a dental resin; the light disbursing surface providing a downwardly directed curved portion; the workpiece defining an axis of symmetry forming an angle of between 103 and 121 degrees with said longitudinal axis.

2. The apparatus of claim 1 wherein the angle between the axis of symmetry and the longitudinal axis is approximately 112 degrees.

3. The apparatus of claim 1 wherein the handle provides a receiving surface and the utility element provides a corresponding insertion surface, the surfaces enabled for engaging and disengaging the utility element with the handle, the utility element enabled, when engaged with the receiving surface of the handle, for selective angular positioning of the axis of symmetry with the longitudinal axis of the handle.

4. The apparatus of claim 3 wherein the receiving surface and the insertion surface are correspondingly tapered.

5. A light concentrating dental tool apparatus for use with a curing lamp, the apparatus comprising: an elongate handle defining a longitudinal axis thereof, and a light transmissive utility element at one end of the handle, the utility element providing an outwardly facing, light receiving, top surface, and a downwardly converging cone-shaped body, the body terminating with an integral workpiece adapted for moving a matrix band; the workpiece providing a light disbursing surface enabled for directing light outwardly therefrom for curing a dental resin; the light disbursing surface providing a downwardly directed flat portion and a downwardly curved portion in mutually opposing juxtaposition; the flat and the curved portions defining a common axis of symmetry forming an angle of between 59 and 77 degrees with said longitudinal axis.

6. The apparatus of claim 5 wherein the angle between the axis of symmetry and the longitudinal axis is approximately 68 degrees.

7. The apparatus of claim 5 wherein the handle provides a receiving surface and the utility element provides a corresponding insertion surface, the surfaces enabled for engaging and disengaging the utility element with the handle, the utility element enabled, when engaged with the receiving surface of the handle, for selective angular positioning of the axis of symmetry with the longitudinal axis of the handle.

8. The apparatus of claim 7 wherein the receiving surface and the insertion surface are correspondingly tapered.

9. A light concentrating dental tool apparatus for use with a curing lamp, the apparatus comprising: an elongate handle defining a longitudinal axis thereof; and a pair of light transmissive utility elements integral with the handle at opposing ends thereof, the utility elements each providing an outwardly facing, light receiving, top surface, and a downwardly converging cone-shaped body, the body terminating with an integral workpiece adapted for moving a matrix band; the workpiece providing a light disbursing surface enabled for directing light outwardly therefrom for curing a dental resin; the light disbursing surface providing a downwardly directed flat portion and a downwardly curved portion in mutually opposing juxtaposition; the flat and the curved portions defining a common axis of symmetry forming an angle, at one end of the handle, of between 59 and 77 degrees with said longitudinal axis, and at the other end of the handle, of between 103 and 121 degrees with said longitudinal axis.

10. The apparatus of claim 7 wherein the angle between the axis of symmetry and the longitudinal axis at the one end is approximately 68 degrees and at the other end is approximately 112 degrees.

11. The apparatus of claim 7 wherein, at each end, the handle provides a receiving surface, each of the utility elements providing a corresponding insertion surface, the surfaces enabled for engaging and disengaging the utility elements with the handle, each of the utility elements enabled, when engaged with one of the receiving surfaces of the handle, for selective angular positioning of the axis of symmetry with the longitudinal axis of the handle.

12. The apparatus of claim 11 wherein the receiving surfaces and the insertion surfaces are correspondingly tapered.

13. A light concentrating dental tool apparatus for use with a curing lamp, the apparatus comprising: an elongate handle defining a longitudinal axis thereof; and a light transmissive utility element at one end of the handle, the utility element providing an outwardly facing, light receiving, top surface, and a downwardly converging hyperbolic outer surface, the utility element terminating with a downwardly depending workpiece adapted for moving a matrix band; the workpiece providing a light disbursing surface enabled for directing light outwardly therefrom for curing a dental resin; the light disbursing surface providing a downwardly directed curved portion; the workpiece defining an axis of symmetry collinear with said longitudinal axis.
